(19) United States
(12) Patent Application Publication
(10) Pub. No.: US 2009/0241740 A1
(43) Pub. Date: Oct. 1, 2009

(54) Universal ratchet wrench

(76) Inventor: Michael Scot Heagerty, Bend, OR (US)

Correspondence Address: Michael S. Heagerty, 19861 Hollygrape Street, Bend, OR, 97702, US

(21) Appl. No.: 12/079,267

(22) Filed: Mar. 25, 2008

(51) Int. Cl. B25B 13/46; B25B 23/16

(52) U.S. Cl. 81/63.1; 81/177.8

(57) ABSTRACT

A ratchet wrench with an improved universal handle comprising a ratchet head and two pivotally interactive handle parts. A first handle part works as a linkage between the ratchet head and a second handle part and is dually connected to the ratchet heads center axis for universal movement. The second handle part includes a receiving channel along its length and is pivotally connected to house the first handle part in a foldable relationship.

### BACKGROUND OF THE INVENTION

1. Field of the Invention

The invention relates to wrenches, specifically ratchet wrenches with adjustably angled handles. More particularly the invention comprises a ratchet wrench featuring an improved double pivoting handle that allows the user to quickly and ergonomically fold and unfold the tools handle in a 180 degree range while providing for various configurations in between.

2. Discussion of the Background

Various fasteners must be turned and are done so efficiently by ratchet wrenches; however confined spaces can often make this a difficult task. Many ratchet wrenches are now made with adjustably angled handles, adjusting at the neck of the tool or at the center axis of the ratchet head. Other ratchet wrenches have incorporated multiple pivot points along the handle's length. The designs allow various angles and configurations to be achieved in confined spaces; however they have done so with certain limitations. Ratchet wrenches heretofore proposed for such use either do not fold far enough or at the right places to allow for universal movement and thereby limiting the tools total possible configurations.

### OBJECTS AND ADVANTAGES OF THE INVENTION

It is an object of the present invention to provide a universally adjustable handle for ratchet wrenches. From the previous descriptions it can be appreciated that the adjustment of such tools is limited. The handles length and possible angles while working in confined spaces often lacks the proper leverage and ergonomics needed by its user. The instant invention features an improved pivotal relationship within its handle parts. This form of handle allows the user to quickly and ergonomically adjust its length and angle as needed by providing a 180 degree range of motion to each of the two handle parts. Within the given range of motion the present invention can be easily adjusted to various configurations, including but not limited to a short handle of any angle, a long handle of any angle, a T-handle and a crank or speed handle.

### SUMMARY OF THE INVENTION

The present ratchet wrench comprises essentially three main parts, a ratchet head, a first handle part and a second handle part. The first handle part interconnects the ratchet head to the second handle part by the use of horizontal pivot points. The second handle part is to be grasped in the hand, thereby allowing the user to manipulate the tool into a desired configuration.

The Invention will be better understood and additional features and advantages will become apparent from the following description of the preferred embodiment illustrated in the accompanying drawings. Various changes may be made in the details and arrangement of parts and certain features may be used without others. All such modifications within the scope of the appended claims are included in the invention.

### BRIEF DESCRIPTION OF THE DRAWING

FIG. 1. is a top plan view of the ratchet wrench in an extended configuration.

FIG. 2. is a side elevation view of the ratchet wrench in an extended configuration.

FIG. 3. is a top plan view of the ratchet wrench in a folded configuration.

FIG. 4. is a side elevation view of the ratchet wrench in a folded configuration.

FIG. 5. is a side elevation view of the folded ratchet wrench in a direct line configuration.

FIG. 6. is a side elevation view of the ratchet wrench in a T wrench configuration.

FIG. 7. is a side elevation view of the ratchet wrench in a crank or speed wrench configuration.

FIG. 8. is an isometric view of the ratchet wrench in a transitional configuration.

### DESCRIPTION OF THE PREFERRED EMBODIMENT

The ratchet wrench comprises a first handle part 3 and a second handle part 1, hingedly connected together by a pivot pin 23. The first handle part 3 includes a yoke 19 whereby a ratchet head 11 is pivotally connected at two pivot points 25. A set screw 13 holds the yoke 19 securely to pivot point 25. A set screw 13 holds the yoke 19 securely to pivot point 25. A twist style, lever 17 controls the ratcheting direction of a socket connecting spline 15.

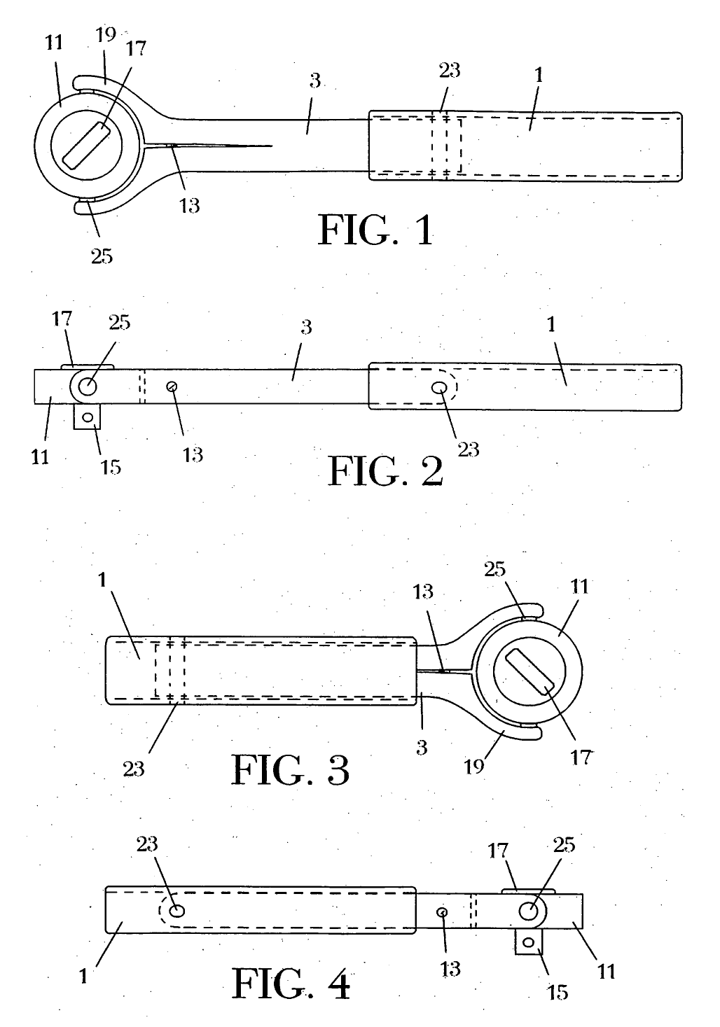

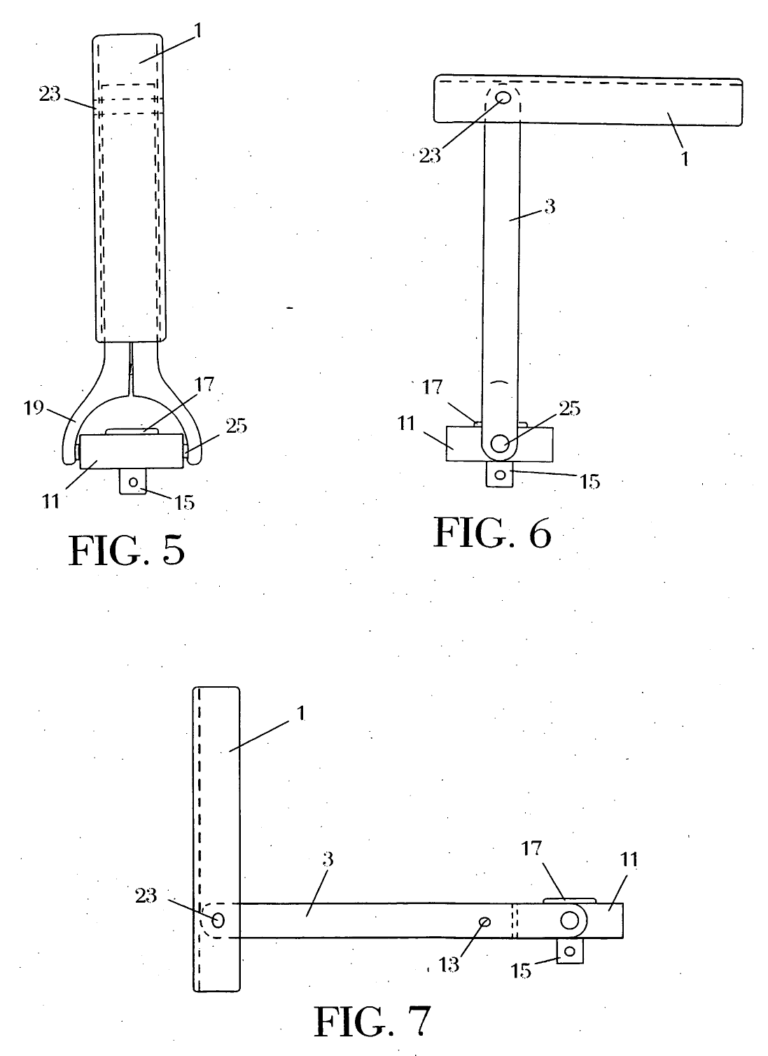

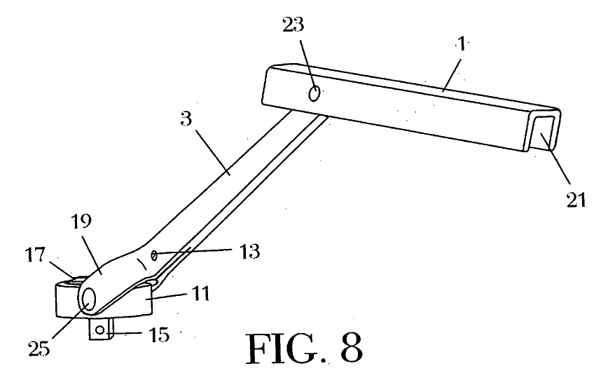

A receiving channel 21 of FIG. 8. within the second handle part 1 allows the 180 degree folding and unfolding of handle parts 1 and 3 on the axis of pivot pin 23. Pivot points 25 allow the handle parts 1 and 3 to swing freely over ratchet head 11 as illustrated in FIG. 1. through FIG. 8.

What is claimed is:

1. A ratchet type wrench comprising: a ratchet head; a first handle part with a first end and a second end; a yoke at said first end of said first handle part pivotally connected to said ratchet head's circumference at dual opposing points; a second handle part with a continuous receiving channel at its entire length pivotally connected to said second end of said first handle part and configured to interact with said first handle part in a 180 degree vertical relationship wherein said handle parts include a minimum of six handle configurations including a foldable shortened handle profile from which said yoke and said ratchet head extend.

2. (canceled)

3. (canceled)

4. (canceled)
